(19) United States
(12) Patent Application Publication
(10) Pub. No.: US 2026/0281392 A1
(43) Pub. Date: Sep. 17, 2026

(54) TEMPLATE MATCHING USING AVAILABLE PERIPHERAL PIXELS

(71) Applicant: GOOGLE LLC, Mountain View, CA (US)

(72) Inventors: Xiang Li, Saratoga, CA (US); In Suk Chong, Mountain View, CA (US); Jingning Han, Santa Clara, CA (US); Debargha Mukherjee, Cupertino, CA (US); Yaowu Xu, Saratoga, CA (US)

(21) Appl. No.: 19/473,305

(22) PCT Filed: Apr. 7, 2023
(86) PCT No.: PCT/US2023/017847

§ 371 Date: Oct. 7, 2025

(51) Int. Cl. H04N 19/182; H04N 19/139; H04N 19/159; H04N 19/176; H04N 19/18; H04N 19/186; H04N 19/52

(52) U.S. Cl. CPC H04N 19/182; H04N 19/139; H04N 19/159; H04N 19/176; H04N 19/18; H04N 19/186; H04N 19/52

(57) ABSTRACT

Coding a current block includes determining that the current block is coded using a template matching mode. In the template matching mode, an initial motion vector for the current block is refined based on template peripheral pixels that are at least a subset of peripheral pixels to the current block. The template peripheral pixels are obtained by excluding pixels of the peripheral pixels that do not meet a template-inclusion condition. A motion vector for the current block is obtained based on a refinement operation that uses the template peripheral pixels and does not use the excluded peripheral pixels. The current block is then coded based on the motion vector.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other coding techniques. These techniques may include both lossy and lossless coding techniques.

### SUMMARY

This disclosure relates generally to encoding and decoding video data and more particularly relates to motion vector coding candidate signaling.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method for coding a current block. The method includes determining that the current block is coded using a template matching mode, where in the template matching mode an initial motion vector for the current block can be refined based on template peripheral pixels that are at least a subset of peripheral pixels to the current block.

The method can include excluding, to obtain the template peripheral pixels, pixels of the peripheral pixels that do not meet a template-inclusion condition.

The method can include obtaining a motion vector for the current block based on a refinement operation that uses the template peripheral pixels and does not use the excluded peripheral pixels.

The method can include coding the current block based on the motion vector.

Other embodiments of this aspect include corresponding computer systems, apparatus, and computer programs recorded on one or more computer storage devices, each configured to perform the actions of the method. Implementations may include one or more of the following features.

The method where the peripheral pixels can be grouped into groups of pixels.

The template-inclusion condition may include that the pixels are coded using an inter-prediction mode.

The template-inclusion condition may include that, with respect to a group of pixels, a block that includes the group of pixels is associated with non-zero transform coefficients.

The template-inclusion condition may include that, with respect to a group of pixels, a block that includes the group of pixels is coded using a skip mode.

The template-inclusion condition may include that, with respect to a group of pixels, a block that includes the group of pixels is not included in a coding unit where blocks of the coding unit are associated with non-zero transform coefficients.

The template-inclusion condition may include that, with respect to a group of pixels, a block that includes the group of pixels is not coded using the template matching mode.

The template-inclusion condition may include that, with respect to a group of pixels, a block that includes the group of pixels is not coded using a decoder-side motion vector refinement.

In a case that the groups of pixels include at least two groups from a same peripheral coding block, excluding, to obtain the template peripheral pixels, the pixels of the peripheral pixels that do not meet the template-inclusion condition can include: excluding from the template peripheral pixels all of the at least two groups in response to determining that at least one of the at least two groups does not meet the template-inclusion condition.

The method where a first of the at least two groups may include luminance data and a second of the at least two groups may include chrominance data.

The method where each group of pixels can have a size of a minimal block size.

The method where minimal block size can be 4×4 pixels.

The method where peripheral pixels include at least one of top peripheral pixels or left peripheral pixels.

Another general aspect includes another method. The method includes determining that a current block is to be coded using a template matching mode. The method can also include identifying available peripheral blocks, where a peripheral block of the current block can be identified as being available in response to determining that the peripheral block meets a template-inclusion condition. The method can also include performing a refinement operation of an initial motion vector identified for the current block to obtain a final motion vector, where the refinement operation uses respective pixels of the available peripheral blocks. The method cn also include coding the current block based on the final motion vector.

Other embodiments of this aspect include corresponding computer systems, apparatus, and computer programs recorded on one or more computer storage devices, each configured to perform the actions of the methods. Implementations may include one or more of the following features.

The method where the template-inclusion condition may include that the peripheral block is coded using an inter-prediction mode.

The method where the template-inclusion condition may include that the peripheral block is associated with non-zero transform coefficients.

The method where the template-inclusion condition may include that the peripheral block is coded using a skip mode.

The method where the template-inclusion condition may include that the peripheral block is not included in a coding unit where blocks of the coding unit are associated with non-zero transform coefficients.

The method where the template-inclusion condition may include that the peripheral block is not coded using the template matching mode.

The method where the template-inclusion condition may include that the peripheral block is not coded using a decoder-side motion vector refinement.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. For example, a non-transitory computer-readable storage medium may include executable instructions that, when executed by a processor, facilitate performance of operations operable to cause the processor to carry out any of the methods described herein. Aspects can be combined such that features described in the context of one aspect may be implemented in another aspect.

These and other aspects of the present disclosure are disclosed in the following detailed description of the embodiments, the appended claims, and the accompanying figures.

### BRIEF DESCRIPTION OF THE DRAWINGS

The description herein refers to the accompanying drawings described below wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of an example of a video stream to be encoded and subsequently decoded.

FIG. 4 is a block diagram of an encoder.

FIG. 5 is a block diagram of a decoder.

FIG. 6 is a diagram of motion vectors representing full and sub-pixel motion.

FIG. 7A illustrates an example of generating a group of motion vector candidates for a current block based on spatial neighbors of the current block.

FIG. 7B illustrates an example of generating a group of motion vector candidates for a current block based on temporal neighbors of the current block.

FIG. 7C illustrates an example of generating a group of motion vector candidates for a current block based on non-adjacent spatial candidates of the current block.

FIG. 8 is an illustration of template matching.

FIG. 9 is an illustration of template matching using available peripheral pixels.

FIG. 10 is an example of a flowchart of a technique for performing motion vector refinement using available peripheral pixels.

FIG. 11 is an example of a flowchart of a technique for performing motion vector refinement using available peripheral pixels.

### DETAILED DESCRIPTION

As mentioned, compression schemes related to coding video streams may include breaking images into blocks and generating a digital video output bitstream (i.e., an encoded bitstream) using one or more techniques to limit the information included in the output bitstream. A received bitstream can be decoded to re-create the blocks and the source images from the limited information. Encoding a video stream, or a portion thereof, such as a frame or a block, can include using temporal similarities in the video stream to improve coding efficiency. For example, a current block of a video stream may be encoded based on identifying a difference (residual) between the previously coded pixel values, or between a combination of previously coded pixel values, and those in the current block.

Encoding using temporal similarities is known as inter prediction or motion-compensated prediction (MCP). A prediction block of a current block (i.e., a block being coded) is generated by finding a corresponding block in a reference frame following a motion vector (MV). That is, inter prediction attempts to predict the pixel values of a block using a possibly displaced block or blocks from a temporally nearby frame (i.e., a reference frame) or frames. A temporally nearby frame is a frame that appears earlier or later in time in the video stream than the frame (i.e., the current frame) of the block being encoded (i.e., the current block). A motion vector used to generate a prediction block refers to (e.g., points to or is used in conjunction with) a frame (i.e., a reference frame) other than the current frame. A motion vector may be defined to represent a block or pixel offset between the reference frame and the corresponding block or pixels of the current frame.

The motion vector(s) for a current block in MCP may be encoded into, and decoded from, a compressed bitstream. A motion vector for a current block is described with respect to a co-located block in a reference frame. The motion vector describes an offset (i.e., a displacement) in the horizontal direction (i.e., MVₓ) and a displacement in the vertical direction (i.e., MV_{y}) from the co-located block in the reference frame. As such, an MV can be characterized as a 3-tuple (f, MVₓ, MV_{y}) where f is indicative of (e.g., is an index of) a reference frame, MVₓ is the offset in the horizontal direction from a collocated position of the reference frame, and MV_{y} is the offset in the vertical direction from the collocated position of the reference frame. As such, at least the offsets MVₓ and MV_{y} are written (i.e., encoded) into the compressed bitstream and read (i.e., decoded) from the encoded bitstream.

As can be appreciated, a substantial number of bits may be required to code motion information, including a motion vector, in a compressed bitstreams Several coding modes can be used to lower the rate cost of encoding motion vectors.

For example, the SKIP and MERGE modes are two coding modes that use a list of candidate MVs (or, equivalently, other blocks) to reduce the rate of encoding MVs. In the SKIP mode, no residual information is transmitted from an encoder to a decoder. The decoder estimates an MV for a current block encoded using the SKIP mode from a list of candidate MVs and uses (e.g., selects) the MV to calculate a motion-compensated prediction for the current block. In the MERGE mode, an MV from the list of candidate MVs is inherited for coding the current block. The list of candidate MVs may also be referred to as a merge list where the merge list may refer to blocks whose MVs (or, more generally, motion information) are used to select an MV (or, more generally, motion information) for a current block. The SKIP can be considered to be a special case of the MERGE mode.

Other techniques or inter-prediction modes can be also used to reduce the number of bits required to code motion information. For example, the REFMV and the NEWMV inter prediction modes of the AV1 codec can also be used to lower the rate cost of encoding motion vectors. The REFMV inter-prediction mode indicates that the MV of a current block is a reference MV obtained from a list of candidate MVs. The NEWMV inter prediction mode can be used when the MV for a current block is not a zero MV, and is not any of the candidate MVs. In the NEWMV mode, the MV of the current block may be coded differentially using a reference MV from the list of candidate motion vectors.

As such, and at least as illustrated with respect to some of the coding modes described above, there is generally a need to construct a list of candidate MVs and to code an index of a reference MV (i.e., a selected MV) of the list of candidate MVs. That is, at the encoder, the list of candidate MVs may be constructed according to predetermined rules and the index of a selected MV candidate may be encoded in a compressed bitstream; and, at the decoder, the list of candidate MVs may be constructed (e.g., generated) according to the same predetermined rules and the index of the selected MV candidate may be either inferred or decoded from the compressed bitstream.

The predetermined rules for generating (e.g., deriving, or constructing and ordering) the list of candidate MVs and the number of candidates in the list may vary by codec. For example, in High Efficiency Video Coding (H.265), the list of candidate MVs can include up to 5 candidate MVs.

Codecs may populate the list of candidate MVs using different algorithms, techniques, or tools (collectively, tools). Each of the tools may produce a group of MVs that are added to the list of candidate MVs. For example, in Versatile Video Coding (H.266), the list of candidate MVs may be constructed using several modes, including intra-block copy (IBC) merge, block level merge, and sub-block level merge. The details of these modes are not necessary for the understanding of this disclosure. H.266 limits the number of candidate MVs obtained using IBC merge, block-level merge, and sub-block level merge, to 6 candidates, 6 candidates, and 5 candidates, respectively. Different codecs may use different techniques for generating lists of candidate MVs. Additionally, different modes of a codec may use different lists of candidate MVs. However, such nuances are not necessary for the understanding of this disclosure. As such, the disclosure merely assumes a use of a list of candidate MVs.

To lower the rate cost of encoding the motion vectors (other than in the MERGE or SKIP modes), a motion vector may be encoded differentially. Namely, a predicted motion vector (PMV) is selected as a reference motion vector, and only a difference (also called the motion vector difference (MVD)) between the motion vector (MV) and the reference motion vector is encoded into the bitstream. The reference (or predicted) motion vector may be a motion vector of one of the neighboring blocks, for example, and may be selected from a list of list of candidate MVs. Thus, DMV=MV−PMV. The neighboring blocks can include spatial neighboring blocks (i.e., blocks in the same current frame as the current block). The neighboring blocks can include temporal neighboring blocks (i.e., blocks in frames other than the current frame). An encoder codes DMV in the compressed bitstream; and a decoder decodes the DMV from the compressed bitstream and adds it to prediction motion vector (PMV) to obtain the motion vector (MV) of a current block.

In some situations, the prediction block that results in the best (e.g., smallest) residual may not correspond with pixels in the reference frame. That is, the best motion vector may point to a location that is between pixels of blocks in the reference frame. In this case, motion compensated prediction at the sub-pixel level is useful. MCP may involve the use of a sub-pixel interpolation filter that generates filtered sub-pixel values at defined locations between the full pixels (also called integer pixels) along rows, columns, or both. The interpolation filter may be one of a number of interpolation filters available for use in motion compensated prediction. Sub-pixel interpolation is further described below.

Coding an MV may include coding the horizontal offset (i.e., MVₓ) and coding the vertical offset (i.e., MV_{y}) of the motion vector or the coding the horizontal offset (i.e., MVDₓ) and coding the vertical offset (i.e., MVD_{y}) of the motion vector difference. When implemented by an encoder, “coding” means encoding in a compressed bitstream. When implemented by a decoder, “coding” means decoding from an compressed bitstream.

Several inter-prediction modes may be available. For example, one available inter-prediction mode represents that the motion vector of a block is 0. This may be referred to as a ZEROMV mode. Another inter-prediction mode may represent that the motion vector of the block is the reference motion vector. This may be referred to as a REFMV mode. When the motion vector for the block is not zero, and is different from the reference motion vector, the motion vector may be encoded using a reference motion vector. This mode may be referred to as a NEWMV mode. When the inter-prediction mode is NEWMV, then an MVD may be coded for the MV. Other inter-prediction modes may be available.

To further reduce the number of bits required to code the motion information, decoder-side motion-vector derivation (DMVD) modes have been developed. DMVD modes are inter-prediction modes that can be characterized by deriving or refining motion information for a current block at the decoder.

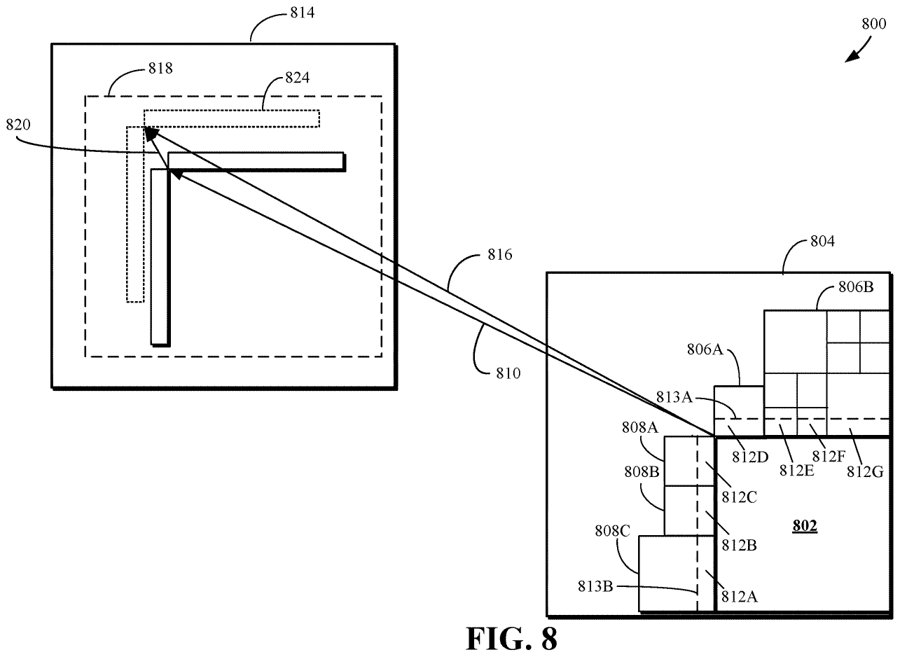

One such mode is referred to as a Template Matching (TM) mode, which is further described below with respect to FIG. 8. To summarize, in the TM mode, initial motion information (e.g., an initial motion vector) identified for a current block is refined by finding a closest match between a template, which includes top and/or left neighboring blocks of a current block in a current frame and a same sized template in a reference frame. The template includes (e.g., is composed of) reconstructed pixels that are peripherally adjacent to the current block. The peripherally adjacent pixels can be or include pixels above and/or pixels to the left of the current block.

Thus, to carry out the TM mode, the peripherally adjacent pixels must be available (i.e., must have been reconstructed) prior to being used in a refinement operation. However, availability of the (reconstructed) peripheral pixels can cause delays in codecs that use parallelism in decoding blocks. To illustrate, if the decoder determines that a current block is to be decoded using the TM mode but that at least some of the top or left peripheral pixels are not available (i.e., have not been reconstructed), then decoding of the current block stops (i.e., is paused) until all of top and left peripheral pixels are available (i.e., have been reconstructed). Pausing the decoding of a current block can incur pipeline delay in hardware codec implementations and can seriously degrade the parallelism of hardware-implemented codecs.

Implementations according to this disclosure solve problems such as these by excluding, from the matching process used in the TM mode, peripheral pixels that are not available. Whether certain peripheral pixels are available to be used for the matching process can be determined based on whether the certain peripheral pixels meet one or more template-inclusion conditions. The subset of the peripheral pixels that meet template-inclusion conditions are used in the matching process and the remaining peripheral pixels that do not meet any template-inclusion condition are not used in the matching process. Accordingly, no delays are incurred in decoding a current block when decoding of the current block may be carried in parallel with the decoding of peripheral blocks that may be used (i.e., pixels therein may be used) in the TM mode.

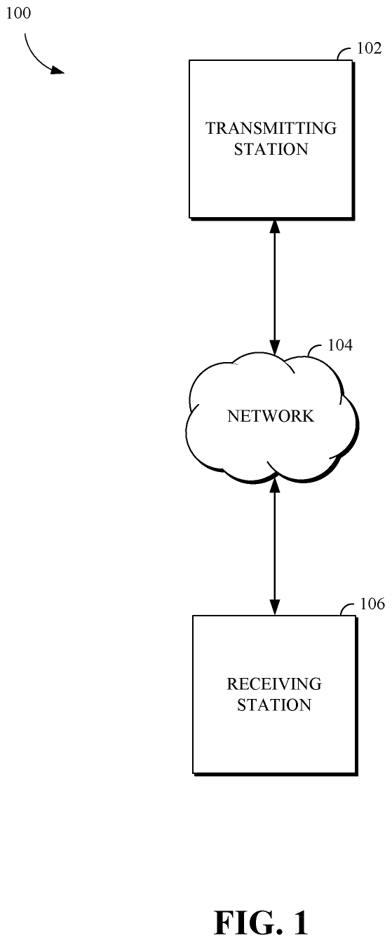

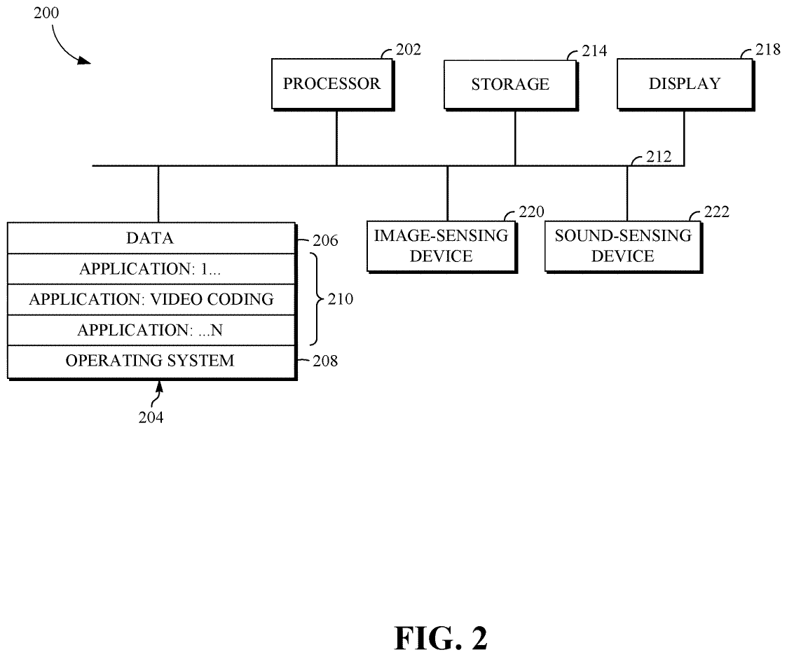

Further details of template matching using available peripheral pixels are described herein with initial reference to a system in which it can be implemented. FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol (HTTP) video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 (e.g., an apparatus) that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown, e.g., the CPU 202, advantages in speed and efficiency can be achieved using more than one processor.

A memory 204 in computing device 200 can be a read only memory (ROM) device or a random-access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described here. For example, the application programs 210 can include applications 1 through N, which further include a video coding application that performs the methods described here. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more of processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

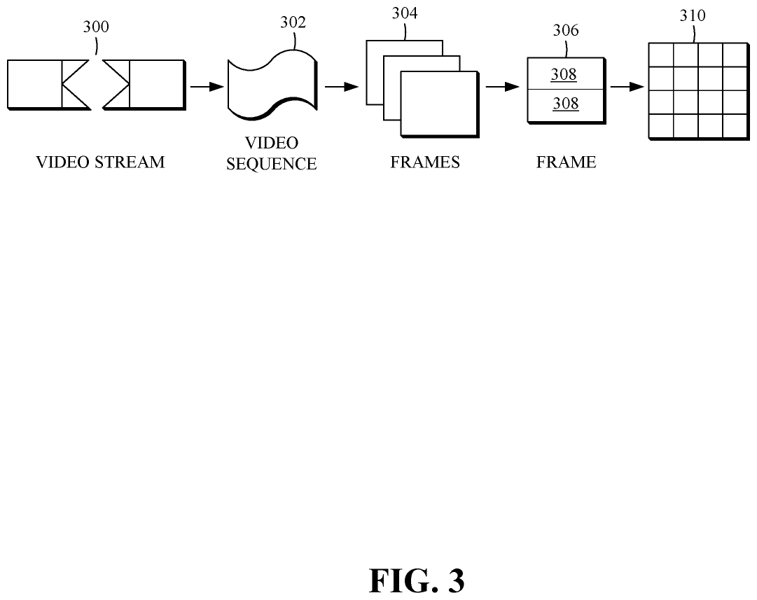

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macro-block are used interchangeably herein.

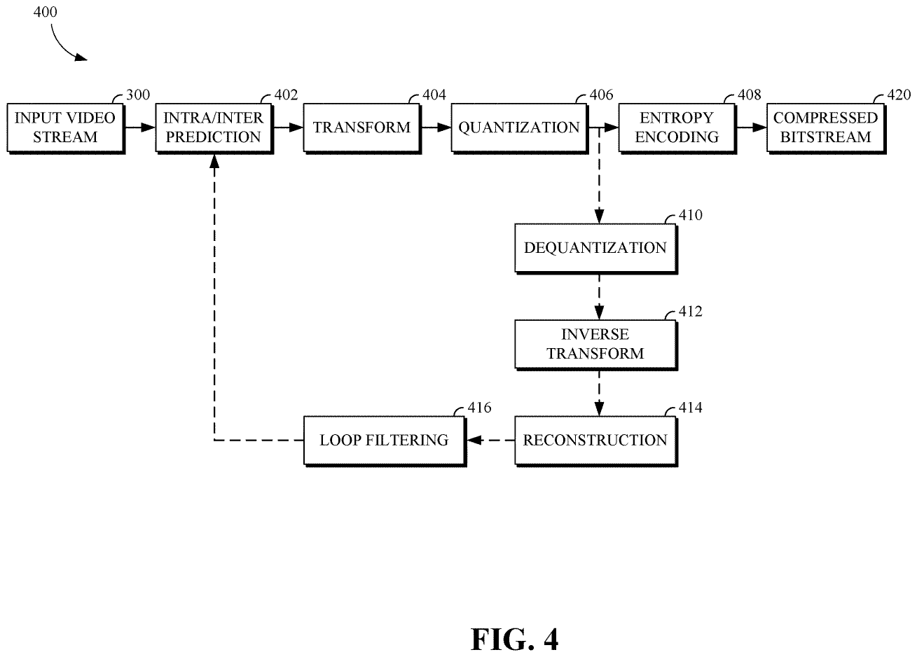

FIG. 4 is a block diagram of an encoder 400. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, motion vectors and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform-based encoder can quantize the residual signal directly without the transform stage 404 for certain blocks or frames. In another implementation, an encoder can have the quantization stage 406 and the dequantization stage 410 combined in a common stage.

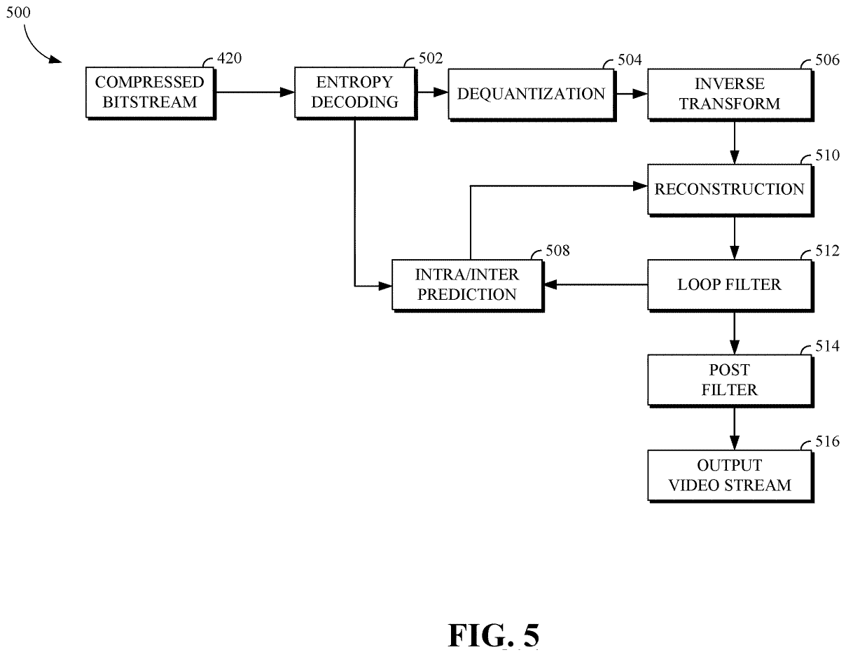

FIG. 5 is a block diagram of a decoder 500. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a post-loop filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the post-loop filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the post-loop filtering stage 514.

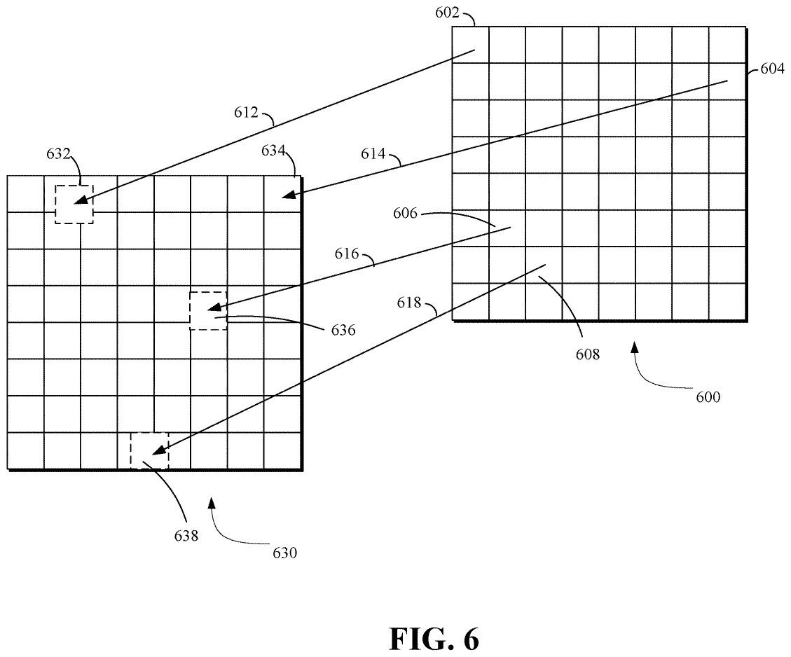

FIG. 6 is a diagram of motion vectors representing full and sub-pixel motion. In FIG. 6, several blocks 602, 604, 606, 608 of a current frame 600 are inter predicted using pixels from a reference frame 630. In this example, the reference frame 630 is a reference frame, also called the temporally adjacent frame, in a video sequence including the current frame 600, such as the video stream 300. The reference frame 630 is a reconstructed frame (i.e., one that has been encoded and decoded such as by the reconstruction path of FIG. 4) that has been stored in a so-called last reference frame buffer and is available for coding blocks of the current frame 600. Other (e.g., reconstructed) frames, or portions of such frames may also be available for inter prediction. Other available reference frames may include a golden frame, which is another frame of the video sequence that may be selected (e.g., periodically) according to any number of techniques, and a constructed reference frame, which is a frame that is constructed from one or more other frames of the video sequence but is not shown as part of the decoded output, such as the output video stream 516 of FIG. 5.

A prediction block 632 for encoding the block 602 corresponds to a motion vector 612. A prediction block 634 for encoding the block 604 corresponds to a motion vector 614. A prediction block 636 for encoding the block 606 corresponds to a motion vector 616. Finally, a prediction block 638 for encoding the block 608 corresponds to a motion vector 618. Each of the blocks 602, 604, 606, 608 is inter predicted using a single motion vector and hence a single reference frame in this example, but the teachings herein also apply to inter prediction using more than one motion vector (such as bi-prediction and/or compound prediction using two different reference frames), where pixels from each prediction are combined in some manner to form a prediction block.

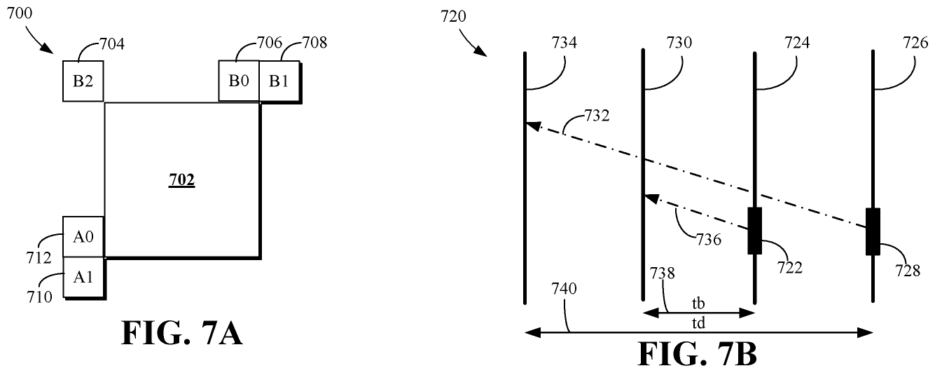

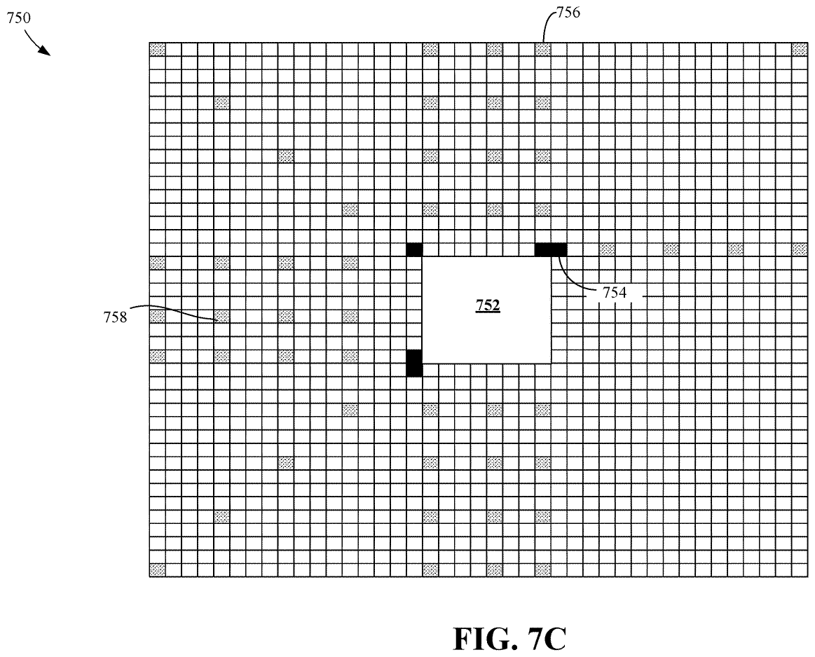

FIGS. 7A-7C illustrate examples of tools for generating groups of motion vectors. As mentioned above, a list of candidate MVs may be obtained using different tools. An encoder, such as the encoder 400 of FIG. 4, and a decoder, such as the decoder 500 of FIG. 5, may use the same tools for obtaining (e.g., populating, constructing, etc.) the same list of candidate MVs. The candidate MVs obtained using a tool are referred to herein as a group of candidate MVs. At least some of the tools described herein may be known or may be similar to or used by other codecs. However, the disclosure is not limited to or by any particular tools that can generate groups of MV candidates. The groups of motion vectors may be or may be combined to form a list of candidate MVs.

As mentioned above, merge candidates or candidate MVs may be derived using different tools. Some such tools are now described. Depending on the inter-prediction mode, different motion information may be coded in a compressed bitstream, such as the compressed bitstream 420 of FIG. 4 or 5. For example, if a block is coded using the MERGE mode, a reference frame index and a motion vector of the list of candidate MVs are set as the reference frame index and motion vector of the block. A merge candidate corresponding to a merge index (e.g., the index of the candidate in the list of candidate MVs) is selected from the merge candidate list and the motion information of the merge candidate is set as the motion information of the block. The merge index (e.g.,) the index of the candidate in the list of candidate MVs may be coded in the compressed bitstream. For example, if a motion vector is coded differentially, an MVP is selected from list of candidate MVs. The index of the MVP in the list of candidate MVs may be included in the compressed bitstream. The MVD may also be included (i.e., coded) in the compressed bitstream. Additionally, a reference frame index may also be included (i.e., coded) in the compressed bitstream.

FIG. 7A illustrates an example 700 of generating a group of motion vector candidates for a current block based on spatial neighbors of the current block. The example 700 may be referred to or may be known as generating or deriving spatial merge candidates. The spatial merge mode is limited to merging with spatially-located blocks in the same picture.

A current block 702 may be “merged” with one of its spatially available neighboring block(s) to form a “region.” FIG. 7A illustrates that spatially available neighboring blocks includes blocks 704-712 (i.e., blocks 704, 706, 708, 710, 712). As such, up to six MV candidates (i.e., corresponding to the MVs of the blocks 704-712) may be possible (i.e., added to the list of candidate motion vectors or the merge list). However, more or fewer spatially neighboring blocks may be considered. In an example, a maximum of four merge candidates may be selected from amongst candidate blocks 704-712.

All pixels within the merged region share the same motion parameters (e.g., the same MV(s) and reference frame(s)). Thus, there is no need to code and transmit motion parameters for each individual block of the region. Instead, for a region, only one set of motion parameters is encoded and transmitted from the encoder and received and decoded at the decoder. In an example, a flag (e.g., merge_flag) may be used to specify whether the current block is merged with an available neighboring block. Additionally, an index of the MV candidate in the list of MV candidates of the neighboring block with which the current block is merged.

FIG. 7B illustrates an example 720 of generating a group of motion vector candidates for a current block based on temporal neighbors of the current block. The example 720 may be referred to or may be known as generating or deriving temporal merge candidates or as a temporal merge mode. In an example, the temporal merge mode may be limited to merging with temporally co-located blocks in neighboring frames. In another example, blocks in other frames other than a co-located block may also be used.

A co-located block may be a block that is in a similar position as the current block in another frame. Any number of co-located blocks can be used. That is, the respective co-located blocks in any number of previously coded pictures can be used. In an example, the respective co-located blocks in all of the previously coded frames of the same group of pictures (GOP) as the frame of the current block are used. Motion parameters of the current block may be derived from temporally-located blocks and used in the temporal merge.

The example 720 illustrates that a current block 722 of a current frame 724 is being coded. A frame 726 is a previously coded frame, a block 728 is a co-located block in the frame 726 to the current block 722, and a frame 730 is a reference frame for the current frame. A motion vector 732 is a the motion vector of the block 728. The frame 726, which includes the co-located block 728, may be referred to as the “collocated picture” or collocated frame.” The motion vector 732 points to a reference frame 734. The reference frame 734, which is the reference frame of the collocated picture, may be referred to as the “collocated reference picture” or the “collocated reference frame.” As such, a motion vector 736, which may be a scaled version of the motion vector 732 can be used as a candidate MV for the current block 722. The motion vector 732 can be scaled by a distance 738 (denoted tb) and a distance 740 (denoted td). The distance can be the picture order count (POC) or the display order of the frames. As such, in an example, tb can be defined as the POC difference between the reference frame (i.e., the frame 730) of the current frame (i.e., the current frame 724) and the current frame; and td is defined to be the POC difference between the reference frame (i.e., the reference frame 734) of the co-located frame (i.e., the frame 726) and the co-located frame (i.e., the frame 726).

FIG. 7C illustrates an example 750 of generating a group of motion vector candidates for a current block 752 based on non-adjacent spatial candidates of the current block. A current block 752 illustrates a largest coding unit (which may be further divided into sub-blocks), which may be divided into sub-blocks and where at least some of the sub-blocks may be inter predicted. Blocks that are filled with the black color, such as a block 754, illustrate the neighboring blocks described with respect to FIG. 7A. Blocks filled with the dotted pattern, such as blocks 756, 758 are used for obtaining the group of motion vector candidates for the current block 752 based on non-adjacent spatial candidates.

An order of evaluation of the non-adjacent blocks may be predefined. However, for brevity, the order is not illustrated in FIG. 7C and is not described herein. The group of candidate MVs based on non-adjacent spatial candidates may include 5, 10, fewer, or more MV candidates.

Another example (not illustrated) of generating a group of MV candidates (or merge candidates) for a current block can be history based MV derivation, which may be referred to as history based MV prediction (HMVP) mode.

In the HMVP mode, the motion information of a previously coded block can be stored in a table and used as a candidate MV for a current block. The table with multiple HMVP candidates can be maintained during the encoding/decoding process. The table can be reset (emptied) when a new row of largest coding units (which may be referred to as a superblock or a macroblock) is encountered.

In an example, The HMVP table size may be set to 6, which indicates that up to 6 HMVP candidate MVs may be added to the table. When inserting a new candidate MV into the table, a constrained first-in-first-out (FIFO) rule may be utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table can be checked in order and inserted to the candidate MV list after the temporal merge candidate. A codec may apply redundancy check on the HMVP candidates to the spatial or temporal merge candidate(s).

Yet another example (not illustrated) of generating a group of candidate MVs for a current block can be based on averaging predefined pairs of MV candidates in the already generated groups of MV candidates of the list of MV candidates.

Pairwise average MV candidates can be generated by averaging predefined pairs of candidates in the existing merge candidate list, using motion vectors of already generated groups of MVs. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors can be averaged even when they point to different reference frames, and the reference frame for the average MV can be set to be the same reference frame as that of p0Cand; if only one MV is available, use the one directly; if no motion vector is available, keep this list invalid. Also, if the half-pel interpolation filter indices of p0Cand and p1Cand are different, the half-pel interpolation filter is set to 0.

In yet another example (not illustrated), a group of zero MVs may be generated. A current reference frame of a current block may use one of N reference frames. A zero MV is a motion vector with displacement (0, 0). The group of zero MVs may include 0 or more zero MVs with respect to at least some of the N reference frames.

It is again noted that the tools described herein for generating groups of candidate MVs does not limit the disclosure in any way and that different codecs may implement such tools differently or may include fewer or more tools for generating candidate MVs or merge candidates.

To summarize, a conventional codec may generate a list of candidate MVs using different tools. Each tool may be used to generate a respective group of candidate MVs. Each group of candidate MVs may include one or more candidate MVs. The candidate MVs of the groups are appended to the list of candidate MVs in a predefined order. The list of candidate MVs has a finite size and the different tools are used until the list is full. For example, the list of candidate MVs may be of size 6, 10, 15, or some other size. For example, spatial merge candidates may be first be added to the list of candidate MVs. If the list is not full, then at least some of temporal merge candidates may be added. If the list is still not full, then at least some of the HMVP candidates may be added. If the list is still not full, then at least some of the pairwise average MV candidates may be added. If the list is still not full, then zero MVs may be added. The size of the list of candidate MVs may be signaled in the compressed bitstream and the maximum allowed size of the merge list may be pre-defined. For each coding unit, an index of the best merge candidate may be encoded using truncated unary binarization. In an example, the first bin of the merge index may be coded with context and bypass coding may be used for other bins.

Additionally, conventional codecs may perform redundancy checks so that a same motion vector is not added more than once at least in the same group of candidate MVs. To illustrate, after the candidate at position A₁ of FIG. 7A (i.e., the block 710) is added, the addition of the remaining candidates may be subject to a redundancy check to ensure that candidates with the same motion information are excluded from the list. As another illustration, redundancy checks may be applied on the HMVP candidates with the spatial or temporal merge candidates. In some codecs, and to reduce the number of redundancy check operations, simplifications may be introduced, such as, once the total number of available merge candidates reaches the maximally allowed merge candidates minus 1, the merge candidate list construction process from HMVP is terminated.

FIG. 8 is an illustration 800 of template matching. As already mentioned, the TM mode is a decoder-side motion vector derivation mode used to refine an initial motion vector of a current block by finding a closest match between a template in a current frame that includes the current block and a template in a reference frame.

The illustration 800 includes a current block 802 of a current frame 804. The illustration 800 shows that blocks 806A and 806B are above-neighboring blocks of the current block 802; and blocks 808A, 808B, and 808C are left-neighboring blocks of the current block 802. Each of the neighboring blocks may be partitioned further into smaller blocks. While a certain partitioning of the neighboring blocks is shown, other partitionings are possible. Additionally, while two above-neighboring blocks and three left-neighboring blocks are shown, the disclosure is not so limited and more or fewer neighboring blocks are possible.

An initial motion vector 810 (i.e., MVᵢ) is identified (e.g., selected) for the current block 802. In an example, the initial motion vector 810 may be identified by decoding, from a compressed bitstream, an index into a list of candidate MVs. Peripheral pixels that are part of the above-and left-neighboring blocks form a template that is used to refine the initial motion vector 805. The template is formed by the peripheral pixels that are below a line 813A and the peripheral pixels that are to the right of a line 813B. The peripheral pixels that form the template are referred to herein as “template peripheral pixels.” The template peripheral pixels are obtained from (e.g., belong to or are part of) different neighboring blocks. For example, template peripheral pixels 812A, 812B, 812C, 812D, 812E, 812F, and 812G are obtained from the blocks 808C, 808B, 808A, 806A, 806B, 806B, and 806B, respectively.

A better (refined or final) MV (i.e., a final motion vector 816) is searched around the initial motion vector 810 of the current block in a reference frame 814 within a search range 818. In an example, the search range 818 can be a [−8, +8]-pel search range. A search step size for the final motion vector 816 can be based on the mode used to for the selection of the initial motion vector 810. To illustrate, the Versatile Video Coding (VVC) standard uses a the motion vector coding modes referred to as advanced motion vector prediction (AMVP) or merge coding. Different motion vector precisions are possible with each of the modes. Additionally, the search technique within the search range 818 may be different for the different modes. The AMVP mode may be characterized by differential coding of the motion vector. The specifics of the TM motion vector refining process (e.g., the search for the final motion vector 816) are not necessary to the understanding of this disclosure. The refinement process identifies a motion vector refinement 820 (i.e., ΔMV). Thus, the final motion vector 816 is obtained as MVᵢ+ΔMV. The motion vector refinement that results in the smallest error between the template and the corresponding template in the reference frame is selected as the motion vector refinement 820. The error can be the absolute sum difference (SAD) or some other error metric. The pixels in the reference frame 814 corresponding to the template peripheral pixels are referred to herein as template peripheral pixels (e.g., template peripheral pixels 824).

In the AMVP mode, a motion vector prediction (MVP) candidate may be refined with the TM mode. The TM refinement may start from full-pel MV difference precision (or 4-pel for 4-pel advanced motion vector resolution (AMVR) mode) within a search range (e.g., [−8, +8]-pel search range) by using iterative diamond search. The AMVP candidate may be further refined by using cross search with full-pel MVD precision (or 4-pel for 4-pel AMVR mode), followed by half-pel and quarter-pel refinement depending on the AMVR mode as specified. Such a search process can ensure that the MVP candidate still keeps the same MV precision as indicated by the AMVR mode after the TM refining process. In the search process, if the difference between a previous minimum cost and a current minimum cost in the iteration is less than a threshold that is equal to the area of the block, the search process terminates. For blocks in merge mode, a similar search process can be applied to the merge candidate indicated by a merge index. The TM matching process may perform a search all the way down to ⅛-pel MVD precision or skipping those beyond half-pel MVD precision, depending on whether the alternative interpolation filter (as indicated by columns AltIF=0 and AltIF=1), which is used when AMVR is of half-pel mode, is used according to merged motion information.

As mentioned above, the above described refinement operation of the TM mode cannot be performed for the initial motion vector 810 until all of the peripheral pixels 812A-812G are available, which may cause delays.

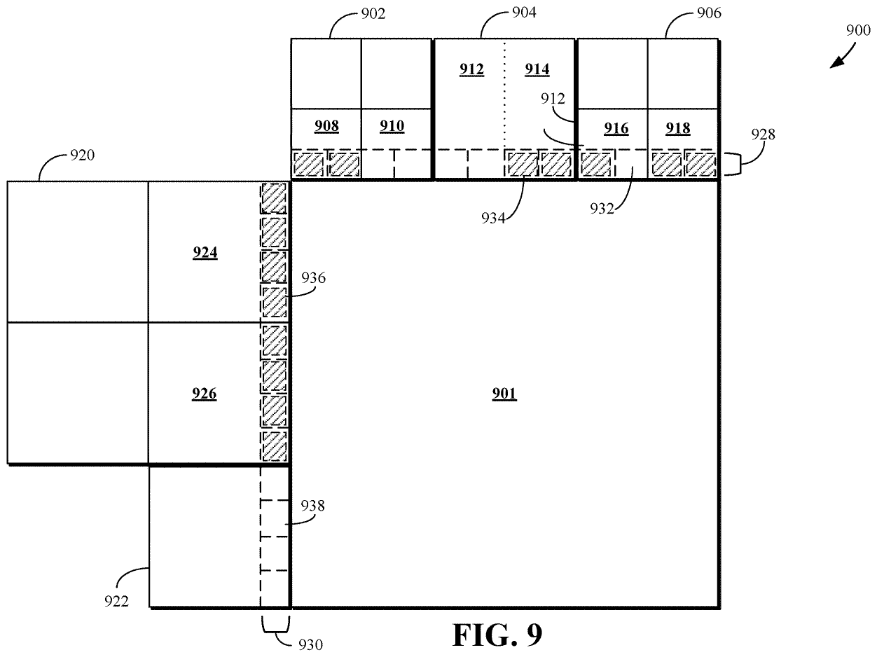

FIG. 9 is an illustration 900 of template matching using available peripheral pixels. In the illustration 900, certain of the peripheral pixels may be considered (i.e., marked as) available or unavailable depending on whether the certain peripheral pixels meet or don't meet a template-inclusion condition. If peripheral pixels meet a template-inclusion condition then they are considered available and are used in the TM matching (or refinement) process; otherwise, they are excluded from the matching process. That certain peripheral pixels meet the template-inclusion condition means that the peripheral block (or a coding unit (CU) that includes the peripheral block) to which the certain peripheral pixels belong itself meets the template-inclusion condition. As become clear from the following description, template matching using available peripheral pixels can result in a set of template peripheral pixels that includes fewer template peripheral pixels than the templates described with respect to FIG. 8.

The illustration 900 includes a current block 901 that is coded using the TM mode. Above-neighboring blocks of the current block 901 include blocks 902, 904, and 906. The block 902 is further partitioned into blocks including blocks 908 and 910. The block 906 is further partitioned into blocks including blocks 916 and 918. Left-neighboring blocks of the current block 901 include blocks 920 and 922. The block 920 is split into sub-blocks including blocks 924 and 926. The block 904 is coded using a mode referred to as sub-block transform, which is further described below.

Template peripheral pixels used for obtaining a motion vector for the current block 901 include a number R of rows of pixels above the current block 901 and a number C of columns of pixels to the left of the current block 901. In an example, the number of rows R can be 1, 2, 3, 4, or some other number of rows. In an example, the number of columns C can be 1, 2, 3, 4, or some other number of columns. In an example, and to reduce computational complexity, the number of rows and the number of columns can be one (i.e., R=C=1). In another example, the number of rows R and columns C can be set based on a minimal possible block size of a luminance block predicted using inter-prediction. In certain codecs, the minimal possible block size is 4×4. As such, each of the number of rows R and columns C can be set to 4 (i.e., R=C=4).

Furthermore, the template peripheral pixels can be partitioned (e.g., grouped) into sub-template pixel groups. Each above sub-template pixel group can have a size of W×R, where W is the number of pixels that constitute the width of the sub-template pixel group; and each left sub-template pixel group can have a size of C×H, where H is the number of pixels that constitute the height of the sub-template pixel group. In an example, W and H can be equal. In an example, each of the sub-template pixel groups can have a size that is equal to the minimal possible block size. As such, in an example, each of the sub-template pixel groups can have a size of 4×4 (i.e., C=R=W=H=4).

A determination is made with respect to each of the sub-template pixel groups whether the sub-template pixel group is available or unavailable for use in the matching process. In FIG. 9, each sub-template pixel group is shown as a dashed square, such as sub-template groups 932 and 934. A sub-template pixel group that is available for the refinement operation is illustrated in FIG. 9 as further including a patterned box; and a sub-template pixel group that does not include a patterned box is considered unavailable. To illustrate, sub-template groups 934 and 936 are available, and sub-template groups 932 and 938 are unavailable.

That a sub-template pixel group is available means that that sub-template pixel group is used in the refinement operation. In an example, if any of the top sub-template pixel groups are unavailable, then all of the top sub-template pixel groups are considered unavailable. Similarly, if any of the left sub-template pixel groups are unavailable, then all of the left sub-template pixel groups are considered unavailable. In another example, only those sub-template pixel groups that are unavailable are excluded from the refinement operation. As such, the above and/or the left template may not be a continuous set of pixels (i.e., a continuous set of sub-template pixel groups).

The principle behind template matching using available peripheral pixels is to avoid delays stemming from having to wait for reconstructions of all of the template peripheral pixels to become available. Again, reconstruction of the template peripheral pixels means reconstruction of the blocks that include the template peripheral pixels. A decoder need not wait for reconstruction of a peripheral block to complete if the reconstructed pixels of the peripheral block are determined to be the same as the prediction pixels for that block. That is, for example, when it can be determined that the peripheral block is not associated with residual data. That is, no residual data (i.e., pixels) are needed to reconstructed the blocks. That a peripheral block is associated with residual data can mean that a compressed bitstream include residual data corresponding to the peripheral. The residual data can be non-zero transform coefficients.

Reconstruction speed cannot be used (e.g., relied upon) to determine whether a peripheral block has been reconstructed at least because an encoder and a decoder cannot not be guaranteed to have the same speeds. Therefore, conditions other than speed are to be used to synchronize an encoder and a decoder. Prediction modes for coding the peripheral blocks can be used to synchronize the encoder and the decoder: the prediction modes encoded in the bitstream by the encoder are the same prediction modes used by the decoder to decode the peripheral blocks.

As described above with respect to FIG. 5, and with respect to the reconstruction path of FIG. 4, to reconstruct a block, a prediction block for the block is first obtained; and the prediction block is added to a residual block (which may be decoded from a compressed bitstream). The residual block may be obtained by dequantizing and inverse transforming transform coefficients. In some situations, as further described herein, a residual may be zero and, as such, the prediction block is all that is needed. When the residual is zero, then the reconstruction is equal to the prediction. Whether a peripheral block is associated with a residual block can be determined based on the prediction mode of the peripheral block.

In the following, statements such “if a peripheral block is determined to be coded using a mode X, then each of its sub-template pixel groups are considered available/unavailable (as the case may be)” should be considered to be equivalent to “when considering a sub-template pixel group, if the peripheral block of which the sub-template pixel group is a part is coded using a mode X, then the sub-template pixel group is considered available/unavailable (as the case may be).”

If a peripheral block is not coded using an inter-prediction mode, then its sub-template pixel groups are considered to be unavailable. For example, if a peripheral block is coded using an intra-prediction mode, then all of the sub-template pixel groups that are part of the peripheral block are considered (e.g., marked as) unavailable at least because blocks coded using intra-prediction may be considered to require considerable pipeline time, therewith causing pipeline delays. To illustrate, the block 922 may be associated with (e.g., coded using) an intra-prediction mode. As such, the sub-template pixel groups that are part of the block 922, such as the sub-template group 938 are considered unavailable. Similarly, if a block is coded using a palette-based prediction mode, then its sub-template pixel groups are considered unavailable.

If a block is associated with non-zero transform coefficients, then all of its sub-template pixel groups are considered unavailable. This is so because reconstructing the block incurs the time costs of reading the coefficients from the compressed bitstream, dequantization them, and inverse transforming them in order to use in reconstructing the block.

To illustrate, the block 904 may be coded using the sub-block transform mode in which an inter-predicted block is coded with a special pattern. The sub-block transform mode is a coding mode used in VVC. The pattern can be a binary split pattern, as illustrated with respect to the block 904. However, other patterns are possible. As such, the block 904 is further partitioned into sub-blocks 912, 914. The sub-block transform mode is characterized by one the sub-blocks of the pattern having non zero coefficients and the other having zero coefficients. In FIG. 9, the sub-bock 914 is assumed to be the one with zero coefficients. As such, the sub-template pixel groups of the sub-bock 914, such as the sub-template groups 934, are considered available whereas the sub-template groups of the sub-block 912 are considered unavailable. As another example, in the AV1 standard, a syntax element (all_zero), when equal to 1, specifies that all transform coefficients of a transform block are zero.

In an example, if a peripheral block is coded using an inter-prediction code other than the SKIP mode, then its sub-template pixel groups are considered unavailable. As mentioned above, in the SKIP mode, no residual information is transmitted from an encoder to a decoder. Equivalently, if a peripheral block is coded using the SKIP mode, then its sub-template pixel groups are considered available. To illustrate, the block 924 may be determined to be coded using the SKIP mode. As such, all of its sub-template pixel groups are considered available.

A peripheral block may be part of a coding unit, which may include blocks corresponding to different color components. As is known, a largest coding unit (sometimes called a super-block or a macro-block), which may have a size of 128×128 pixels, 64×64 pixels, or some other size, can be recursively decomposed all the way down to blocks having sizes as small as, in an example, 4×4 pixels for a luminance component. A coding unit may include coding blocks of different color components. For example, a coding unit may include one luma coding block and two chroma coding blocks in the case of a 4:2:0 chroma format. In another example, a coding unit may include one coding block of a single component. For example, a coding unit may contain only one luma coding block or one or more chroma coding blocks.

If any of the blocks included in the same coding unit as a peripheral block are not associated with zero residuals, then the sub-template pixel groups of the peripheral block are considered unavailable. If the coding unit that includes the peripheral block does not include other coding blocks, then the no-zero residuals constraint is only evaluated with respect to the peripheral block itself. In an example, a coding unit that includes only chrominance coding blocks (e.g., Cb and Cr coding blocks, or U and V coding blocks) is considered to be a coding unit that includes different color components.

If a peripheral block is itself coded using the TM mode, then all of its sub-template pixel groups are marked as unavailable. Since generating the motion vector(s) and, thus, a reconstruction of such a block may introduce delay, then its sub-template pixel groups are marked as unavailable. In an example, and more generally, if a peripheral block is coded using any mode that relies or performs decoder-side motion vector refinement, then all of its sub-template pixel groups can be marked as unavailable. The rationale for such a constraint is that delays may result if derivation of the prediction data depend on a derivation of a motion vectors.

The top peripheral blocks belong to a different row of coding units. In a decoder hardware implementation, the decoder may process coding units in row, raster scan order. As such, no delays may be incurred due to the top template since the row of coding units that is above the current block may be reconstructed prior to decoding the current block. On the other hand, at least some coding units of the left template may be processed in parallel with the current block 901. As such, in an example, the top template and/or top sub-template pixel groups may be marked as available whereas whether the left template and/or left sub-template pixel groups are to marked as available or unavailable may be further signaled by an encoder in the compressed bitstream, such as in a sequence parameter set, a picture parameter set, a picture header, or slice a header. At decoder, if the signal is true (i.e., always mark the top neighbors as available), the decoder will only check the availability of the left peripheral pixels (unless the current block aligns with the top of the current frame or the top of a tile boundary).

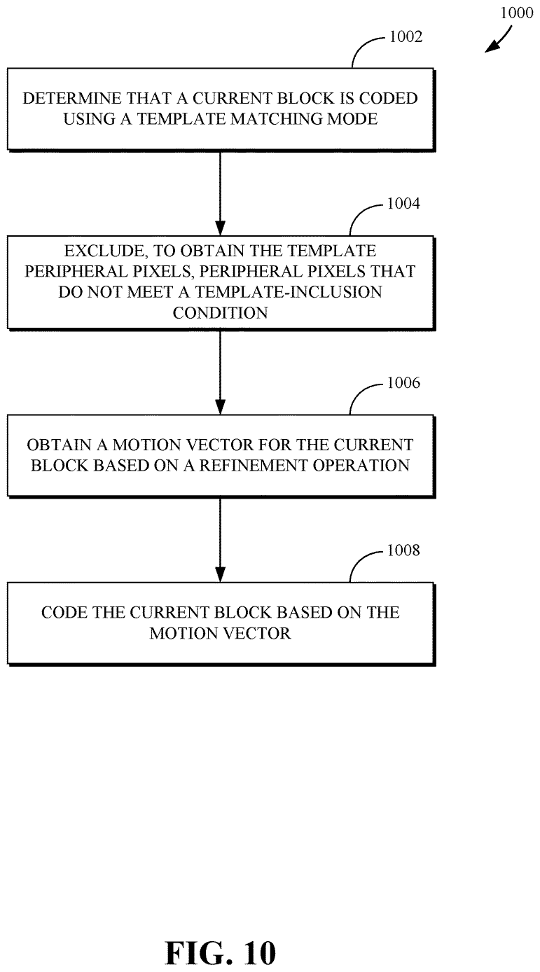

FIG. 10 is an example of a flowchart of a technique 1000 for performing motion vector refinement using available peripheral pixels. The motion vector obtained by the technique 1000 is used to code a current block.

The technique 1000 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 1000. The technique 1000 may be implemented in whole or in part in the intra/inter prediction stage 508 of the decoder 500 of FIG. 5 or the intra/inter prediction stage 402 of the encoder 400 of FIG. 4. As such, when implemented by a decoder, “coding” means “decoding;” and when implemented by an encoder, “coding” means “encoding.” The technique 1000 can be implemented using specialized hardware or firmware. Multiple processors, memories, or both, may be used.

At 1002, the current block is determined to be coded using a template matching mode. When implemented by an encoder, the encoder determines that the current block is to be encoded using the TM mode and encodes in a compressed bitstream, such as the compressed bitstream 420 of FIG. 4, one or more syntax elements indicating that the current block (or a coding unit that includes the current block) is to be decoded using the TM mode. When implemented by a decoder, the decoder determines that the current block is to be decoded using the TM mode by decoding the one or more syntax elements from the compressed bitstream.

As described above, in the TM mode, an initial motion vector for the current block is refined based on template peripheral pixels that are at least a subset of peripheral pixels to the current block. The peripheral pixels can include top peripheral pixels, left peripheral pixels, or both. As also described above, the initial motion vector can be indicated at least by an index into a list of candidate motion vectors. In an example, the initial motion vector can be differentially coded. In an example, the initial motion vector can be indicated by a merge index.

At 1004, template peripheral pixels are obtained by excluding peripheral pixels that do not meet a template-inclusion condition. The template peripheral pixels are used in a refinement operation to obtain a motion vector refinement, such as described with respect to the motion vector refinement 820 (i.e., ΔMV) of FIG. 8. In an example, the peripheral pixels can be grouped into groups of pixels (i.e., into sub-template pixel groups). Each group of pixels may have a size of a minimal block size. The minimal block size can be 4×4 pixels. The groups of pixels may include at least two groups from a same peripheral coding block. In an example, excluding, to obtain the template peripheral pixels, the pixels of the peripheral pixels that do not meet the template-inclusion condition can include excluding from the template peripheral pixels all of the at least two groups in response to determining that at least one of the at least two groups does not meet the template-inclusion condition.

At 1006, a motion vector (i.e., a refined or final motion vector) for the current block is obtained based on the refinement operation that uses the template peripheral pixels and does not use the excluded peripheral pixels. The refinement operation includes performing a search for the (optimal) motion vector refinement within a search range indicated by the initial motion vector. The refinement operation results in identifying a motion vector refinement that minimizes a difference between the template peripheral pixels and corresponding template peripheral pixels in a reference frame.

At 1008, the current block is coded based on the motion vector. When implemented in a decoder, coding the current block based on the motion vector can include reconstructing the block based on the motion vector by obtaining a prediction block for the current block using the motion vector, decoding a residual block for the current block, and adding the prediction and residual blocks. When implemented by an encoder, coding the current block based on the motion vector can include obtaining a prediction block for the current block using the motion vector, subtracting the prediction block from the current block to obtain a residual block, and encoding the residual block in a compressed bitstream.

In an example, the template-inclusion condition can be or include that the pixels are coded using an inter-prediction mode. In an example, the template-inclusion condition can be or include that, with respect to a group of pixels, a block that includes the group of pixels is associated with non-zero transform coefficients. In an example, the template-inclusion condition can be or include that, with respect to a group of pixels, a block that includes the group of pixels is coded using a skip mode. In an example, the template-inclusion condition can be or include that, with respect to a group of pixels, a block that includes the group of pixels is not included in a coding unit such that blocks of the coding unit are associated with non-zero transform coefficients. In an example, the template-inclusion condition can be or include that, with respect to a group of pixels, a block that includes the group of pixels is not coded using the template matching mode. In an example, the template-inclusion condition can be or include that, with respect to a group of pixels, a block that includes the group of pixels is not coded using a decoder-side motion vector refinement.

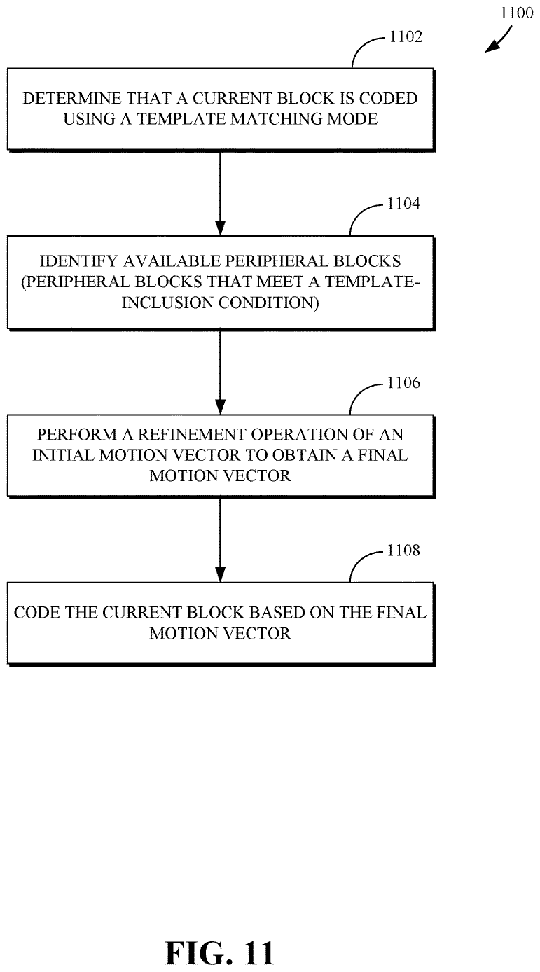

FIG. 11 is an example of a flowchart of a technique 1100 for performing motion vector refinement using available peripheral pixels. The motion vector obtained by the technique 1100 is used to code a current block.

The technique 1100 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 1100. The technique 1100 may be implemented in whole or in part in the intra/inter prediction stage 508 of the decoder 500 of FIG. 5 or the intra/inter prediction stage 402 of the encoder 400 of FIG. 4. As such, when implemented by a decoder, “coding” means “decoding;” and when implemented by an encoder, “coding” means “encoding.” The technique 1100 can be implemented using specialized hardware or firmware. Multiple processors, memories, or both, may be used.

At 1102, the current block is determined to be coded using a template matching mode. The determination can be made as described with respect to 1002 of FIG. 10. At 1104, peripheral blocks of the current block that meet a template-inclusion condition are identified as being available. A peripheral block can be identified as being available if the peripheral block is coded using an inter-prediction mode. A peripheral block can be identified as being available if the peripheral block is the peripheral block is associated with non-zero transform coefficients. A peripheral block can be identified as being available if peripheral block is coded using a skip mode. A peripheral block can be identified as being available if the peripheral block is not included in a coding unit wherein blocks of the coding unit are associated with non-zero transform coefficients. A peripheral block can be identified as being available if the peripheral block is not coded using the template matching mode. A peripheral block can be identified as being available if the peripheral block is not coded using a decoder-side motion vector refinement.

At 1106, a refinement operation of an initial motion vector identified for the current block is performed to obtain a final motion vector. The refinement operation uses respective pixels of the available peripheral blocks, such as described with respect to FIG. 9. At 1108, the current block is coded based on the final motion vector, which can be as described with respect to 1008 of FIG. 10.

For simplicity of explanation, the techniques described herein, such as the techniques 1000 and 1100 of FIGS. 10 and 11, respectively, are depicted and described as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a non-transitory computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

1. A method for coding a current block, comprising:
determining that the current block is coded using a template matching mode, wherein in the template matching mode an initial motion vector for the current block is refined based on template peripheral pixels that are at least a subset of peripheral pixels to the current block;
excluding, to obtain the template peripheral pixels, pixels of the peripheral pixels that do not meet a template-inclusion condition;
obtaining a motion vector for the current block based on a refinement operation that uses the template peripheral pixels and does not use the excluded peripheral pixels; and
coding the current block based on the motion vector.

2. The method of claim 1, wherein the peripheral pixels are grouped into groups of pixels.

3. The method of claim 2, wherein the template-inclusion condition comprises that the pixels are coded using an inter-prediction mode.

4. The method of claim 2, wherein the template-inclusion condition comprises that, with respect to a group of pixels, a block that includes the group of pixels is associated with non-zero transform coefficients.

5. The method of claim 2, wherein the template-inclusion condition comprises that, with respect to a group of pixels, a block that includes the group of pixels is coded using a skip mode.

6. The method of claim 2, wherein the template-inclusion condition comprises that, with respect to a group of pixels, a block that includes the group of pixels is not included in a coding unit wherein blocks of the coding unit are associated with non-zero transform coefficients.

7. The method of claim 2, wherein the template-inclusion condition comprises that, with respect to a group of pixels, a block that includes the group of pixels is not coded using the template matching mode.

8. The method of claim 2, wherein the template-inclusion condition comprises that, with respect to a group of pixels, a block that includes the group of pixels is not coded using a decoder-side motion vector refinement.

9. The method of claim 2, wherein the groups of pixels include at least two groups from a same peripheral coding block, and
wherein excluding, to obtain the template peripheral pixels, the pixels of the peripheral pixels that do not meet the template-inclusion condition comprises:
excluding from the template peripheral pixels all of the at least two groups in response to determining that at least one of the at least two groups does not meet the template-inclusion condition.

10. The method of claim 9, wherein a first of the at least two groups comprise luminance data and a second of the at least two groups comprise chrominance data.

11. The method of claim 1, wherein each group of pixels has a size of a minimal block size.

12. The method of claim 11, wherein the minimal block size is 4×4 pixels.

13. The method of claim 1, wherein peripheral pixels include at least one of top peripheral pixels or left peripheral pixels.

14. A method, comprising:
determining that a current block is to be coded using a template matching mode;
identifying available peripheral blocks, wherein a peripheral block of the current block is identified as being available in response to determining that the peripheral block meets a template-inclusion condition;
performing a refinement operation of an initial motion vector identified for the current block to obtain a final motion vector, wherein the refinement operation uses respective pixels of the available peripheral blocks; and
coding the current block based on the final motion vector.

15. The method of claim 14, wherein the template-inclusion condition comprises that the peripheral block is coded using an inter-prediction mode.

16. The method of claim 14, wherein the template-inclusion condition comprises that the peripheral block is associated with non-zero transform coefficients.

17. The method of claim 14, wherein the template-inclusion condition comprises that the peripheral block is coded using a skip mode.

18. The method of claim 14, wherein the template-inclusion condition comprises that the peripheral block is not included in a coding unit wherein blocks of the coding unit are associated with non-zero transform coefficients.

19. The method of claim 14, wherein the template-inclusion condition comprises that the peripheral block is not coded using the template matching mode.

20-26. (canceled)

27. A non-transitory computer-readable storage medium comprising executable instructions that, when executed by a processor, cause the processor to perform operations for coding a current block, the operations comprising:
determining that the current block is coded using a template matching mode, wherein in the template matching mode an initial motion vector for the current block is refined based on template peripheral pixels that are at least a subset of peripheral pixels to the current block;
excluding, to obtain the template peripheral pixels, pixels of the peripheral pixels that do not meet a template-inclusion condition;
obtaining a motion vector for the current block based on a refinement operation that uses the template peripheral pixels and does not use the excluded peripheral pixels; and
coding the current block based on the motion vector.
